(19) United States
(12) Patent Application Publication
(10) Pub. No.: US 2026/0115936 A1
(43) Pub. Date: Apr. 30, 2026

(54) ENHANCED END EFFECTOR

(71) Applicant: Sony Group Corporation, Tokyo (JP)

(72) Inventors: Andreas GEIER, Tokyo (JP); Gagan KHULLAR, Tokyo (JP)

(73) Assignee: Sony Group Corporation, Tokyo (JP)

(21) Appl. No.: 18/928,694

(22) Filed: Oct. 28, 2024

(51) Int. Cl. B25J 15/02; B25J 13/08; B25J 15/08

(52) U.S. Cl. CPC B25J 15/0253; B25J 13/081; B25J 15/08

(57) ABSTRACT

In some implementations, an end effector system may include a gripper platform, a tool base operatively coupled to the gripper platform, a fingertip device mounted to the gripper platform, a finger base configured to exchangeably mount the fingertip device, and a tool configured to be exchangeably mounted on the tool base. The end effector system may further include a sensor system, an actuator; and a controller configured to facilitate a manipulation task.

### BACKGROUND

Robot grippers are used as end effectors in robotic systems, enabling robots to interact with a surrounding environment. As end effectors, robot grippers are attached to an end of robotic arms and are responsible for manipulating objects, handling tools, and performing a wide variety of tasks. The robot grippers may be designed to replicate a functionality of human hands, offering precision, control, and dexterity to grasp, hold, and move objects.

### SUMMARY

Some implementations described herein relate to an end effector system comprising: a gripper platform; a tool base operatively coupled to the gripper platform; and a fingertip device mounted to the gripper platform.

Some implementations described herein relate to a method, comprising: determining, by a controller of an end effector system, a manipulation task, wherein the end effector system further includes: a gripper platform, a tool base operatively coupled to the gripper platform; multiple tools configured to be available for being exchangeably mounted to the tool base, and a fingertip device mounted to the gripper platform; causing, by the controller and based on the manipulation task, a tool, of the multiple tools, to be exchangeably mounted to the tool base; and causing, by the controller, the manipulation task to be performed using the tool.

Some implementations described herein relate to a non-transitory computer-readable medium storing a set of instructions, the set of instructions comprising: one or more instructions that, when executed by one or more processors of an end effector system, cause the end effector system to: determine a manipulation task, wherein the end effector system further includes: a gripper platform, a tool base operatively coupled to the gripper platform; multiple tools configured to be available for being exchangeably mounted to the tool base, and a fingertip device mounted to the gripper platform; cause, based on the manipulation task, a tool, of the multiple tools, to be exchangeably mounted to the tool base; and cause the manipulation task to be performed using the tool.

### BRIEF DESCRIPTION OF THE DRAWINGS

FIG. 1 is a diagram of an example end-effector system, in accordance with some embodiments of the present disclosure.

FIGS. 2A-2B are diagrams of an example finger, in accordance with some embodiments of the present disclosure.

FIGS. 2C-2D are diagrams of an example tool base, in accordance with some embodiments of the present disclosure.

FIG. 2E is a diagram of an example gripper platform that may be used to perform manipulation tasks, in accordance with some embodiments of the present disclosure.

FIG. 2F is a diagram of example gripper platform configurations, in accordance with some embodiments of the present disclosure.

FIG. 3 is a diagram of an example associated with using an end effector system as a manipulator associated with food presentation and/or plating techniques, in accordance with some embodiments of the present disclosure.

FIG. 4 is a diagram of example components of a device associated with an enhanced end effector, in accordance with some embodiments of the present disclosure.

FIG. 5 is a flowchart of an example process associated with an enhanced end effector, in accordance with some embodiments of the present disclosure.

### DETAILED DESCRIPTION OF EXAMPLE EMBODIMENTS

The following detailed description of example implementations refers to the accompanying drawings. The same reference numbers in different drawings may identify the same or similar elements.

In real-world environments, robot grippers handle diverse objects with varying shapes, sizes, and materials. Although typical robot grippers having varied mechanical designs and operational principles have been developed, the typical robot grippers are statically configured. This static nature hinders their ability to achieve a necessary variability and dexterity to efficiently manage a wide range of manipulation tasks. Moreover, the typical robot grippers often struggle to handle tools other than through direct grasping, further limiting their operational scope due to their inflexible mechanical configurations.

Furthermore, typical robot grippers lack adaptability, significantly hindering efficient handling of diverse objects. Achieving a balance between strength and flexibility remains a significant challenge in developing universal robot grippers capable of managing a wide range of objects. One attempted solution has been a deployment of automatic tool change (ATC) technologies. The ATC technologies allow machinery to transition between different end-effector types automatically, enhancing efficiency and flexibility compared to a single robot gripper. These systems enable the switching of entire robot grippers or the mounting of specific, tailor-made tools, thus addressing the issue of static gripper configurations. However, ATC technologies introduce additional system complexity. Although ATC technologies can establish a set of complementary robot grippers to handle various tasks, the ATC technologies require a well-structured technical setup, making efficient deployment complex and costly. Similarly, the switching of tools necessitates large tool exchange magazines, resulting in a versatile but overly controlled environment.

Additionally, delicate object manipulation presents another challenge. Many robot grippers struggle to handle fragile or irregular items, necessitating the deployment of application-specific sensor technologies, such as fingertips (e.g., fingertip devices) with force, tactile, and/or proximity sensors for active grasp control. Tactile sensors, for example, improve grasp performance for soft object manipulation, but achieving cost-effective, robust, and highly sensitive sensors suitable for real-world environments is challenging. Different fingertips cater to specific needs: compliant fingertips are effective for delicate objects, while rigid fingertips provide stability for robust items. Creating versatile fingertips that adapt seamlessly to various objects, balancing compliance, rigidity, and sensing technology, remains an open challenge.

Accordingly, typical robot gripper technologies lack a design concept that efficiently handles adaptability and dexterity. The complex manipulation tasks posed by real-world environments demand a range of technical specifications that typical robot grippers, including robot grippers that use ATC technologies, cannot fully meet. Furthermore, typical robot grippers are not modular, featuring strictly defined structures and functions that cannot be easily extended or adapted.

Some implementations described herein provide an enhanced end effector system. As an example, an end effector system may include a gripper platform (e.g., a robot gripper) with multiple automatic interfaces (e.g., multiple integrated and automatic electromagnetic and/or electromechanical interfaces) for autonomously attaching, removing, and/or exchanging a wide array of fingertips (e.g., a set of fingertip devices) and/or tools (e.g., a set of tools), as described in more detail elsewhere herein. The multiple automatic interfaces enable modifications to be made to the gripper platform. As an example, the automatic interfaces may enable a modification to a structure of the gripper platform (e.g., a mechanical modification) and/or may enable a modification to a function of the gripper platform (e.g., including an ability to include additional sensors, information transfer, and/or control modes, among other examples).

In contrast to typical robot grippers, the gripper platform, as described in more detail elsewhere herein, integrates at least two types of automatic interfaces (e.g., two types of electromagnetic and/or electromechanical automatic interfaces). As an example, the gripper platform may integrate an automatic fingertip mount (e.g., an electromagnetic or an electromechanical automatic fingertip mount, among other examples) and an automatic tool mount (e.g., an electromagnetic or an electromechanical automatic tool mount, among other examples). In this way, the gripper platform may autonomously attach, remove, and/or exchange various fingertip devices (e.g., specialized fingertip devices, including tweezer-like fingertip devices for small object manipulation and/or tactile fingertip devices for soft object manipulation, among other examples) and/or may autonomously attach, remove, and/or exchange between various tools (e.g., kitchen tools and/or auxiliary tools, among other examples).

In some implementations, the automatic fingertip mount enables automatic mounting of various application-specific fingertip devices, which may include respective application-specific sensors. This enables the gripper platform to manipulate diverse objects with varying shapes, sizes, and materials. Furthermore, the automatic tool mount enables automatic mounting of a wide range of tools (e.g., general and/or application-tailored tools, among other examples), which may be used in isolation, or in functional combination, with the fingertip devices, as described in more detail elsewhere herein.

Furthermore, the combination of multiple mounting points (e.g., electromagnetic and/or electromechanical mounting points via the automatic interfaces) enables the gripper platform to act as an auxiliary drivetrain for actuation of tools (e.g., tools with internal mechanical degrees of freedom, among other examples). This enables the gripper platform to mimic various grasps in a grasp taxonomy for direct object manipulation and tool usage in an enhanced manner compared to typical robot grippers.

In this way, the gripper platform is more versatile and capable of handling diverse manipulation challenges (e.g., in weakly structured environments) while reducing the technical complexities that are associated with typical robot grippers and/or ATC technologies. Additionally, the gripper platform is highly customizable (e.g., for virtually any application-specific modification, among other examples) on an as-needed basis (e.g., from a developer point of view) solving novel manipulation challenges faster than previously possible using typical robot grippers and ATC technologies.

As a result, the end effector system, as described herein, overcomes challenges of typical robot gripper system complexity and adaptability for dexterous manipulation including the handling of fingertip device and/or tools. Thus, the end effector, as described herein, is more versatile and capable of addressing diverse manipulation tasks encountered in various applications (e.g., various real-word applications, among other examples) as compared to typical robot grippers and ATC technologies.

Accordingly, the end effector system, including the gripper platform with integrated automatic interfaces (e.g., electromagnetic and/or electromechanical automatic interfaces) may be used to handle a variety of manipulation tasks (e.g., without manual intervention) while striking a balance between technical complexity, effective manipulation task range, and manipulation efficiency for a wide array of manipulation tasks (e.g., virtually any manipulation tasks).

In this way, some implementations herein provide an end effector system that has intrinsic adaptability (e.g., a capacity of the end effector system to change manipulation capabilities via the automatic fingertip mounts and the automatic tool mount). Intrinsic, because an inherent design feature of the end effector system is to be able to mount various fingertip devices and/or tools and thus be flexibly equipped with necessary capabilities to fulfill a specific task in an automated and/or an autonomous manner. In other words, the end effector system is adaptive to a current manipulation task, as the fingertip devices and/or the tools provide the adaptability by allowing the gripper platform to modify a structure and/or a function to increase suitability for the current manipulation task to be performed. Additionally, some implementations described herein enable a modular development platform for research of robotic manipulator solutions and is therefore well suited for the rapid integration of novel or application-tailored hardware devices (e.g., the end effector system may be used as a hand-held device to acquire real-world information, among other examples).

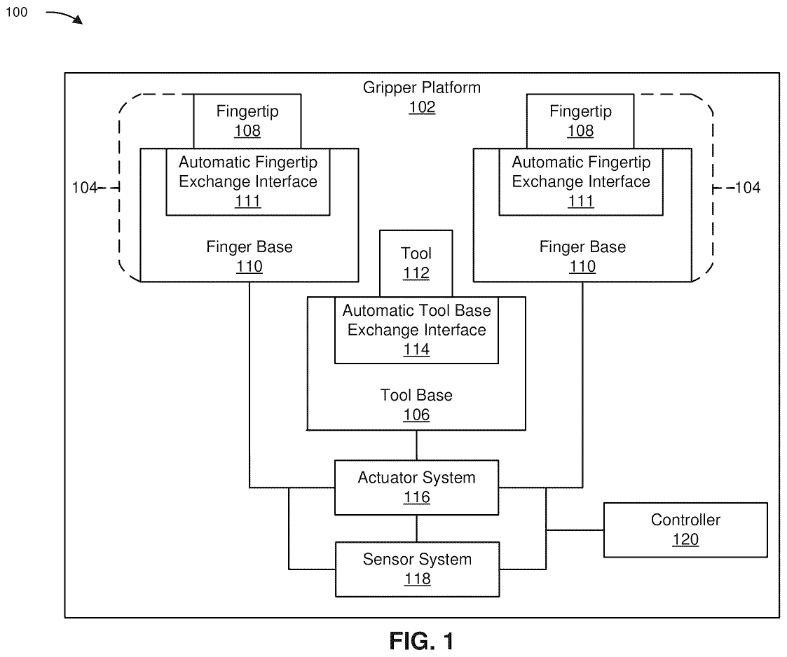

FIG. 1 is a diagram of an example end effector system 100. In some implementations, the end effector system 100 may include integrated automatic mounting points that enable the end effector system 100 to be used as a platform for reconfigurable grippers (e.g., reconfigurable gripper platform configurations including various fingertips and/or tools, among other examples), as described in more detail elsewhere herein. In this way, the end effector system 100 may be used for manipulation tasks, such as manipulations tasks performed in association with a robotic system and/or a hand-held human-based actuated system, among other examples.

As shown in FIG. 1, the end effector system 100 includes a gripper platform 102, multiple fingers 104 operatively coupled to the gripper platform 102, and a tool base 106 operatively coupled to the gripper platform 102. Each finger, of the multiple fingers 104, includes a fingertip 108 (which may also be referred to herein as a fingertip device) and a finger base 110. The fingertip 108 is autonomously releasably attachable to the finger base 110 via an automatic fingertip exchange interface 111, as described in more detail elsewhere herein. A tool 112 is autonomously releasably attachable to the tool base 106 via an automatic tool base exchange interface 114 (e.g., the tool 112 may be selected from multiple tools, as described in more detail elsewhere herein).

As further shown in FIG. 1, the end effector system 100 includes an actuator system 116, a sensor system 118, and a control system 120 (e.g., a controller or a control network, among other examples). In some implementations, the end effector system 100 may use the actuator system 116, the sensor system 118, and/or the control system 120 to perform complex tasks with high precision and adaptability, as described in more detail elsewhere herein.

In some implementations, the actuator system 116 may include one or more actuator components, such as motors (e.g., electric motors), encoders (e.g., rotary and/or linear encoders), hydraulic cylinders, and/or pneumatic actuators, among other examples, which operate in conjunction to control movement of one or more components of the end effector system 100 (e.g., the fingers 104 and/or the tool 112 to directly and/or indirectly manipulate a object, among other examples). Accordingly, for example, the one or more actuator components may provide necessary force, speed, and/or torque to manipulate objects accurately. Furthermore, the rotary and/or the linear encoders may be used to monitor a position and/or a speed of the one or more motors to monitor and/or control movement of the robotic arm, the gripper platform 102, and/or one or more components of the end effector system 100.

In some implementations, the sensor system 118 may include one or more force/torque sensors, tactile sensors, proximity sensors, and/or cameras, among other examples, that detect and/or measure sensor data associated with the end effector system 100 and/or a surrounding environment of the end effector system 100. As an example, the sensors may detect data associated with a grasping force, a position of the target object, and/or an orientation of the target object, among other examples. The sensor data may be continuously fed back to the control system 120 (e.g., via the control network), where it may be processed to understand a state of a current manipulation task.

This enables the end effector system 100 (e.g., via the control system 120) to make adjustments associated with the end effector system 100, such as adjustments to a grip strength of one or more fingers, of the multiple fingers 104, and/or to avoid collisions, among other examples. In some implementations, the multiple sensors may include tactile sensors (e.g., embedded in the multiple fingertips 108), which may sense data associated with a contact pressure and/or an object texture (e.g., of the target object) that is being manipulated during a manipulation task. Additionally, or alternatively, the sensor system 118 may include one or more cameras and/or laser systems, among other examples, for object detection, object recognition, localization, and/or alignment associated with one or more components of the end effector system 100. Although the sensor system 118 is described herein as including particular types of systems, the sensor system 118 may include any suitable sensor system 118.

In some implementations, the control system 120 may include a set of controllers that is distributed vertically (e.g., for low-level position, velocity, and/or torque control to high-level manipulation task control, among other examples) and horizontally (e.g., for object detection, motion planning, and/or grasp regulation, among other examples. The control system 120 may receive data associated with the end effector system 100 and/or a surrounding environment of the end effector system 100 (e.g., actuator data from the actuator system 116 and/or sensor data from the sensor system 118). In this way, the control system 120 may perform one or more actions based on the data, as described in more detail elsewhere herein.

In some implementations, the control system 120 may receive, and/or otherwise obtain, information associated with a gripper platform configuration indicating a set of fingertips and/or a tool necessary to perform a manipulation task (e.g., a spoon, tweezers, and/or a tactile fingertip, among other examples).

The control system 120 may cause (e.g., using the actuator system 116) the gripper platform 102 to form the gripper platform configuration by autonomously releasably attaching the indicated set of fingertips 108 to corresponding finger bases via corresponding automatic fingertip exchange interfaces 111 or the indicated tool 112 to the tool base via the automatic tool base exchange interface 114. In other words, the control system 120 may use the actuator system 116 (e.g., in conjunction with relevant data and/or control algorithms, among other examples) to use a robotic arm to move the gripper platform 102 to the fingertips 108 and/or the tool 112 for the autonomous releasable attachment.

The control system 120 may cause the manipulation task to be performed using the indicated set of fingertips 108 or the indicated tool 112. Accordingly, in some implementations, the gripper platform 102 may be moved via a physical action (e.g., a robot arm and/or a human hand, among other examples) to change a physical configuration of the gripper platform 102 (e.g., via the exchangeable fingertips 108 and/or the tool 112) before performing the manipulation task.

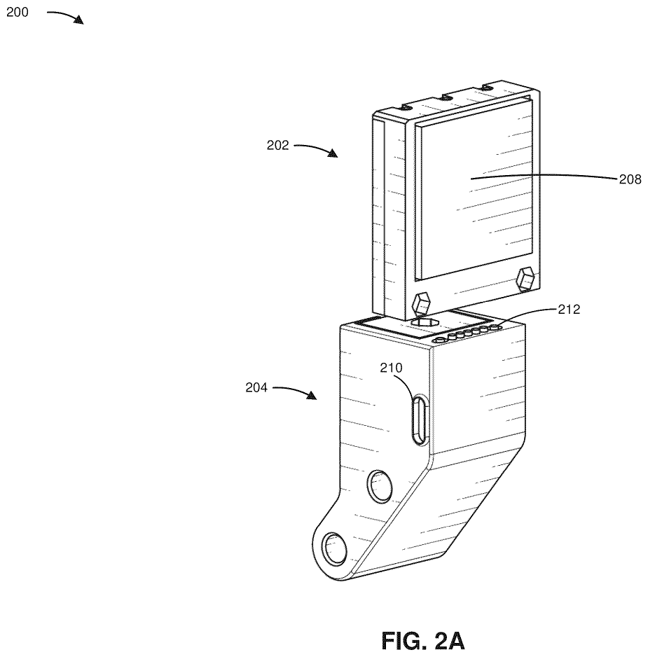

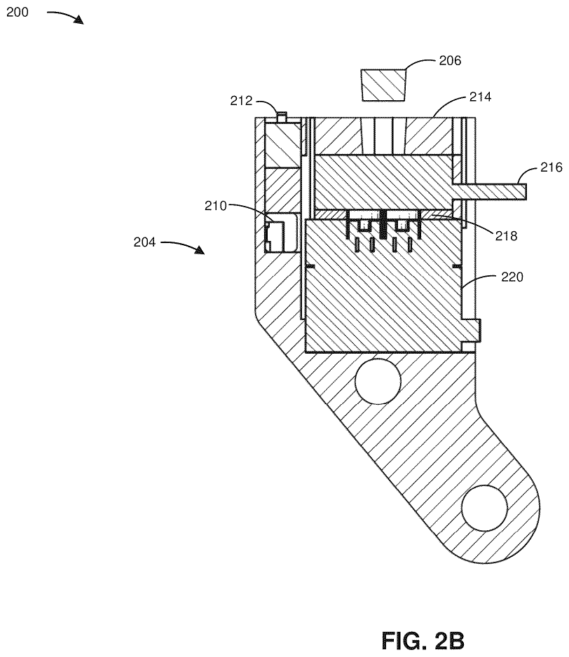

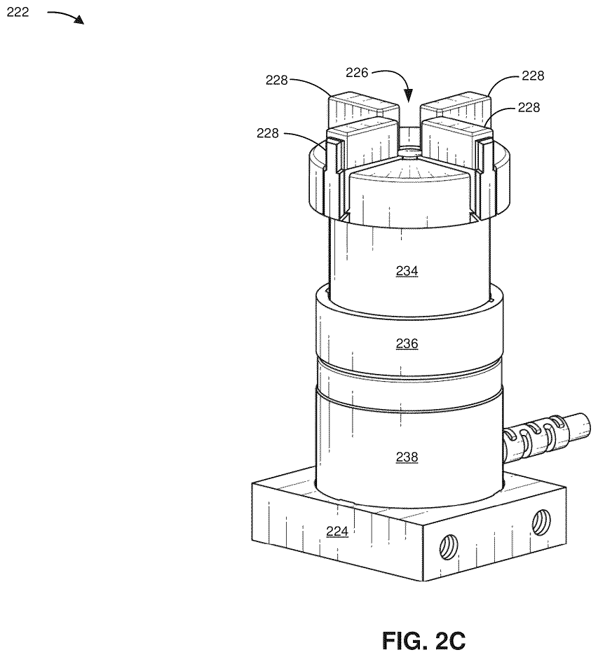

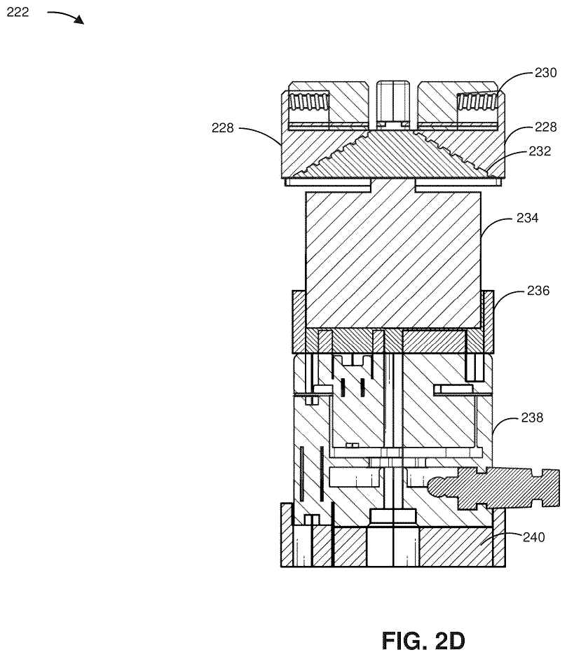

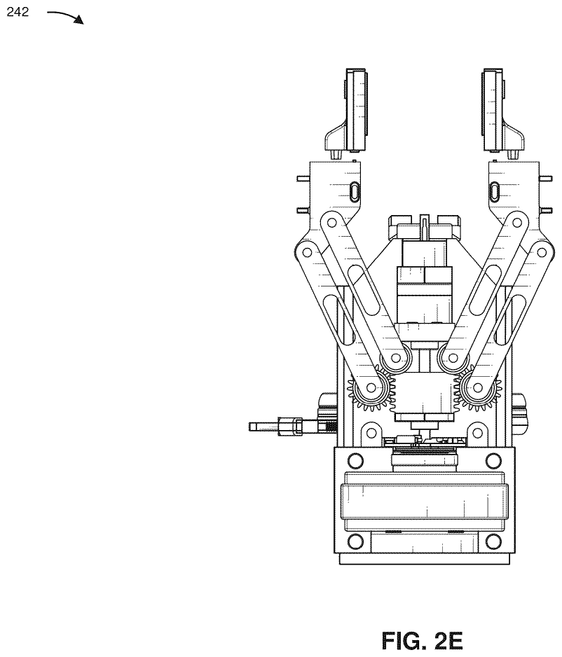

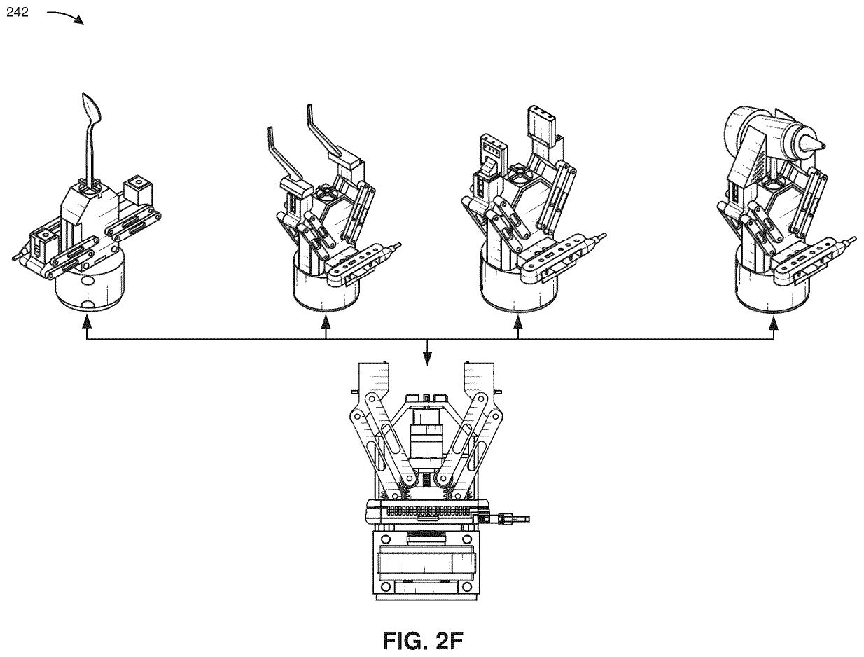

FIGS. 2A-2B are diagrams of an example finger 200 as described herein. As shown in FIGS. 2A-2B, the finger 200 includes a fingertip 202 and a finger base 204. As further shown in FIGS. 2A-2B, the fingertip 202 includes a fingertip-side adapter 206 and a tactile sensor 208 and the finger base 204 includes a communication interface 210 (e.g., shown as a universal serial bus (USB) in FIGS. 2A-2B), a data and power transfer interface 212, a finger-base-side adapter 214, an automatic interface element 216 (e.g., shown as an electromagnet in FIG. 2B), an automatic interface element support 218, and a force/torque sensor 220. Although the finger 200 is shown and described in connection with FIGS. 2A-2B as including particular components, the finger 200 may include any suitable components.

FIGS. 2C-2D are diagrams of an example tool base 222. As shown in FIGS. 2C-2D, the tool base 222 includes a mount 224, an opening 226 (e.g., which enables a tool to be autonomously attached to the tool base 222, removed from the tool base 222, and/or exchanged with other tools, among other examples), compliant jaws 228, a spring 230, a scroll plate 232, a motor 234, a motor support 236, tool base force/torque sensor 238, and a tool base force/torque sensor support 240.

FIG. 2E is a diagram of an example gripper platform 242 that may be used to perform manipulation tasks (e.g., by being operatively coupled to a robotic arm that moves the gripper platform 242, among other examples. The gripper platform 242 may include any suitable components described in more detail elsewhere herein (e.g., one or more components described in connection with the end effector system 100, among other examples).

In some implementations, the fingertip-side adapter 206 and/or the finger-base-side adapter 214 may include high permeability adapter components to facilitate generation of magnetic forces (e.g., pull forces) for quick and robust fingertip device exchange, as described in more detail elsewhere herein. Furthermore, when using compact components with magnetizable adapter pieces, and upon switching the electromagnet (e.g., the electromagnet 246) off, a residual magnetic field remains which can prevent seamless separation of the automatic fingertip mount from the fingertip device (e.g., particularly for lighter tools). Accordingly, in some implementations, the gripper platform 242 may include a demagnetization circuit (e.g., a degaussing circuit), which applies an oscillating magnetic field with attenuating intensity to the adapter components thereby diminishing the residual magnetization.

Furthermore, the automatic fingertip mounts and the fingertip devices may include electrical interfaces for data and power transmission. Additionally, or alternatively, the automatic fingertip mounts may include one or more sensors. As an example, the automatic fingertip mounts may include a force torque sensor, such as a compact electromagnetic-shielded six-axis force/torque sensor to measure one or more forces and/or torques acting on a fingertip device (e.g., a currently attached fingertip device that manipulates an object, among other examples).

In some implementations, the gripper platform 242 may use one or more automatic exchange interfaces (e.g., as described in more detail elsewhere herein) to releasably hold a tool (e.g., an electromechanical interface to releasably hold a tool). For example, the one or more automatic exchange interfaces may use a compliant lathe chuck mechanism, which enables arbitrarily shaped objects to be releasably held. In other words, the compliant lathe chuck mechanism may have a mechanical compliance (or a flexibility) to accommodate variations in mounting mechanisms and/or dimensions of workpieces (e.g., target objects).

As an example, the compliant jaws 228 may be used to mount (e.g., via grasping) a tool. After the tool is mounted, the gripper platform 242 may be controlled to use the tool according to a manipulation task. For example, if the compliant jaws 228 are used to mount a spoon, then movement of the gripper platform 242 may be controlled (e.g., by a robot arm) to scoop and transfer a medium (e.g., a liquid, among other examples) from one location to another location. As another example, if the compliant jaws 228 are used to mount a bottle, then the gripper platform 242 may be controlled to hold the bottle (e.g., via a bottle holding mechanism that is grasped by the compliant jaws 228) such that the fingertips may squeeze a medium (e.g., a liquid, among other examples) out of the bottle.

In some implementations, the controller may include multiple controllers that are communicably coupled to one another, such as via a control network (e.g., a distributed control network). As an example, the control network may be distributed (e.g., via a control network, such as a distributed control network (e.g., the control network may be distributed across dedicated computers, among other examples). One or more components of the gripper platform 242 may connect respectively, via a set of respective drivers, for operating a tactile fingertip device based on tactile sensor data, among other examples, and/or via respective low-level controllers, for regulating a grasp force and/or for operation of the electromotor, among other examples, to computers running respective high-level control algorithms (e.g., for determining a grasp force for stable object manipulation using tactile sensors and a hand-eye camera, among other examples). The computers may be integrated via a control network for execution of decentralized algorithms and the communication to enable complex task execution.

As an example, and as shown in FIG. 2F, the gripper platform 242 may be to perform manipulation tasks using a variety of fingertips and/or tools (e.g., the gripper platform 242 may be used to releasably hold a bottle while using the automatic fingertip mounts to releasably attach tactile fingertips, which are used for manipulating the bottle, among other examples).

Although particular fingertips and tools are shown in connection with FIG. 2F, the gripper platform 242 may be used to autonomously attach, detach, and/or exchange any suitable fingertips and/or tools. In this way, the gripper platform 242 may be used to handle a variety of manipulation tasks (e.g., without manual intervention) while striking a balance between technical complexity, effective manipulation task range, and manipulation efficiency for a wide array of manipulation tasks (e.g., virtually any manipulation tasks).

As indicated above, FIGS. 2A-2F are provided as an example. Other examples may differ from what is described with regard to FIGS. 2A-2F. The number and arrangement of devices shown in FIGS. 2A-2F are provided as an example. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple distributed devices. Additionally, or alternatively, a set of devices (e.g., one or more devices) shown in FIGS. 2A-2F may perform one or more functions described as being performed by another set of devices shown in FIGS. 2A-2F.

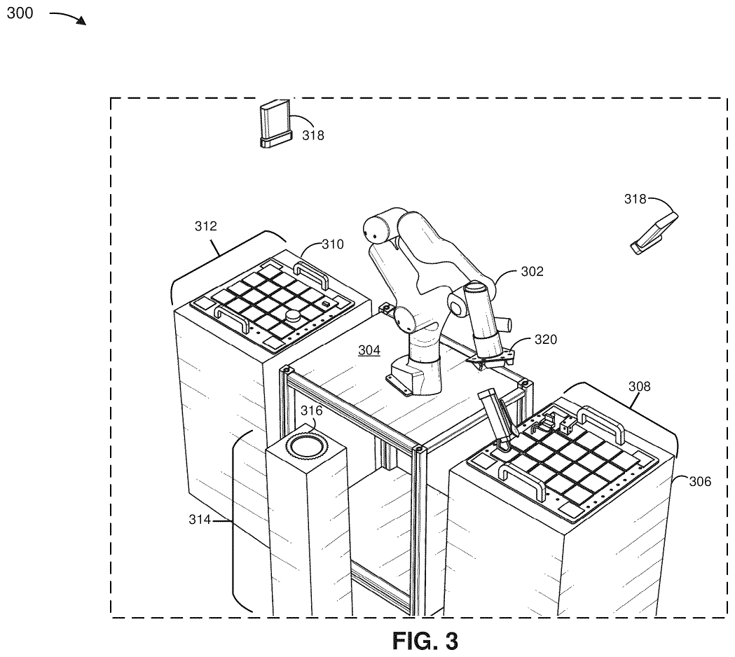

FIG. 3 is a diagram of an example 300 associated with using an end effector system as a manipulator associated with food presentation and/or plating techniques. As shown in FIG. 3, the example 300 includes a robotic arm 302 (e.g., a robotic actuator) mounted on a workstation 304, a tool rack 306 including a set of tools 308, an ingredient rack 310 including a set of ingredients 312, a plating area 314 including a plate 316, cameras 318, and a gripper platform 320.

In some implementations, a controller may receive input data indicating commands (e.g., a request for a manipulation task to be performed). As an example, the input data may be based on manual input, pre-programmed instructions, and/or sensor feedback (e.g., enabling commands to be dynamically generated based on sensor data), among other examples. The controller may interpret the received commands (e.g., which may specify positions, velocities, accelerations, and/or or forces to apply to one or more components of the gripper platform).

In some implementations, the controller may use one or more control techniques (e.g., one or more control algorithms) to generate a trajectory for the robotic arm 302 to follow. This may involve calculating an optimal path that meets indications specified by the commands while avoiding obstacles and minimizing energy consumption or time.

Accordingly, the end effector systems, as described herein may be used for various applications, such as a culinary application. The end effector systems, as described herein may utilize a combination of sensors, machine learning algorithms, and/or precision actuators to select appropriate fingertip devices and/or tools to handle various manipulation tasks (e.g., ingredients from an ingredient rack and/or tools from a tool rack for optimal ingredient selection and plating.

As an example, the end effector system may use one or more sensors to identify and/or classify various ingredients based on various attributes and/or parameters (e.g., shape, size, and/or color, among other examples). After an ingredient is identified, the control device id the end effector system may reference a database (e.g., a pre-programmed database) to determine an optimal fingertip device and/or an optimal tool required for handling the specific ingredient (e.g., tongs, a spatula, or a spoon, among other examples). The end effector system may use one or more machine learning algorithms to adapt to slight variations in an appearance of an ingredient and/or a positioning of an ingredient for presentation, among other examples. In some implementations, a robotic arm operatively connected to the end effector system may move the end effector (e.g., via actuators and/or sensors) to precisely grasp a selected fingertip and/or a selected tool to execute a manipulation task (e.g., artfully arranging the ingredient on a plate, ensuring consistency and aesthetic appeal in the presentation, among other examples).

In some implementations, the end effector system (e.g., via the gripper platform) may be used for imitation learning where an actor (e.g., a robot, an agent, a learner, a controller, and/or an autonomous system, among other examples) learns to perform a task by mimicking one or more actions of an expert (e.g., a human). In some implementations, the gripper platform may include sensors for recording data associated with the human performing a task (e.g., a complex manipulation task, among other examples). As an example, the sensors may include internal sensors (e.g., force/torque sensors of the fingers and/or the tools, among other examples, associated with recording data related to the gripper platform) and/or external sensors (e.g., multi-dimensional pose and orientation sensors associated with recording data related to a pose and orientation of the human hand performing the manipulation task via the gripper platform, among other examples). In this way, a multimodal, rich data set may be obtained and used for various purposes (e.g., AI purposes, among other examples).

For example, the human may be equipped (e.g., may wear) the gripper platform (e.g., of the end effector system), which is equipped with multiple sensors (e.g., accelerometers, gyroscopes, haptic feedback sensors, motion capture sensors, and/or cameras and/or as described in more detail elsewhere herein). The sensors may record data indicative of actions performed by the human during a manipulation task (e.g., movement data, force/torque data, and/or interaction data, among other examples).

In some implementations, the sensors mays end, and a controller of the end effector system may receive, the data. The controller may process the data to extract information (e.g., features, such as torque/force patterns, trajectories, and/or joint angles, among other examples). In this way, the data may represent the actions of the human.

In some implementations, the controller may process the data. As an example, the controller may use the data to train a machine learning model (e.g., a neural network, among other examples) where the machine learning model learns a mapping from the actions of the human to outcomes (e.g., outputs) to accurately capture the actions of the human. After training the model, the machine learning model may be deployed to control another actor equipped with the gripper platform (e.g., a robotic arm equipped with the gripper platform, among other examples). In this way, the machine learning model may be used to control the robotic arm equipped with the gripper platform during performance of manipulation tasks by generating similar actions to the actions of the human. The processes described herein (e.g., which utilize a human to demonstrate a desired behavior effectively) is advantageous compared to typical processes used to control actors (e.g., robotic arms, among other examples) performing a manipulation task (e.g., because the typical processes have difficulty explicitly programming a system to perform manipulation tasks, among other examples).

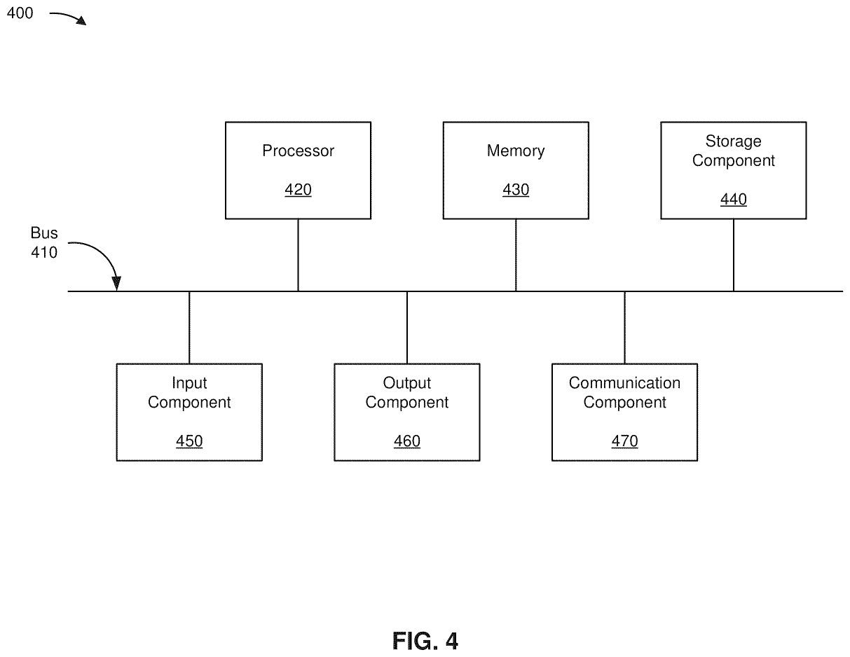

FIG. 4 is a diagram of example components of a device 400, which may correspond to one or more components as described in more detail elsewhere herein. As shown in FIG. 4, the device 400 includes a bus 410, a processor 420, a memory 430, a storage component 440, an input component 450, an output component 460, and a communication component 470.

The bus 410 includes a component that enables wired and/or wireless communication among the components of the device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The Memory 430 includes a random-access memory, a read only memory, and/or another type of memory (e.g., a flash memory, a magnetic memory, and/or an optical memory).

The storage component 440 stores information and/or software related to the operation of the device 400. For example, the storage component 440 may include a hard disk drive, a magnetic disk drive, an optical disk drive, a solid-state disk drive, a compact disc, a digital versatile disc, and/or another type of non-transitory computer-readable medium.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator.

The output component 460 enables the device 400 to provide output, such as via a display, a speaker, and/or one or more light-emitting diodes. The communication component 470 enables device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code, among other examples) for execution by the processor 420. The processor 420 may execute the set of instructions to perform one or more processes described herein. In some implementations, execution of the set of instructions, by one or more of the processors 420, causes the one or more of the processors 420 and/or the device 400 to perform one or more processes described herein. In some implementations, hardwired circuitry may be used instead of, or in combination with, the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

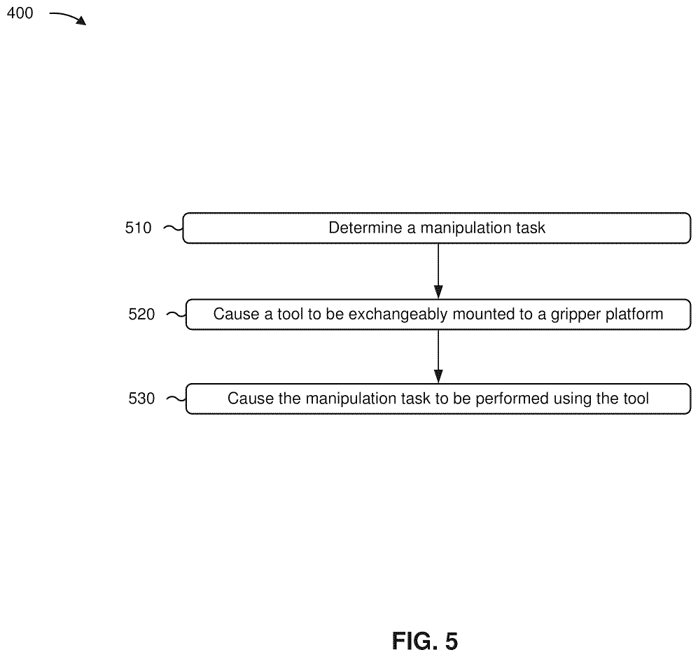

FIG. 5 is a flowchart of an example process 500 associated with an enhanced end effector system. In some implementations, one or more process blocks of FIG. 5 may be performed by one or more components of the end effector systems, as described elsewhere herein in more detail. Additionally, or alternatively, one or more process blocks of FIG. 5 may be performed by one or more components of the device 400, such as the processor 420, the memory 430, the storage component 440, the input component 450, the output component 460, and/or the communication component 470.

As shown in FIG. 5, the process 500 includes determining a manipulation task (block 510). For example, an end effector system may include a gripper platform, a tool base operatively coupled to the gripper platform, and a fingertip device mounted to the gripper platform. The end effector system may determine a manipulation task, as described in more detail elsewhere herein.

As further shown in FIG. 5, the process 500 includes causing a tool to be exchangeably mounted to the gripper platform (block 520). For example, the end effector system may cause the tool to be exchangeably mounted to the gripper platform, as described in more detail elsewhere herein.

As further shown in FIG. 5, the process 500 includes causing the manipulation task to be performed using the tool (block 530). For example, the end effector system may cause the manipulation task to be performed, as described in more detail elsewhere herein.

In some implementations, the end effector system may include a finger base configured to exchangeably mount the fingertip device and/or a tool configured to be exchangeably mounted to the tool base. In some implementations, the gripper platform may be operatively couplable to at least one of a robot or a human. In some implementations, the fingertip device may include at least two fingertip devices mounted to the gripper platform. In some implementations, the end effector system may include multiple tools configured to be available for being exchangeably mounted to the tool base and a controller configured to determine a manipulation task, cause, based on the manipulation task, a tool, of the multiple tools, to be exchangeably mounted to the tool base, and cause the manipulation task to be performed using the tool.

In some implementations, the controller may be further configured to cause the fingertip device to directly manipulate the tool to perform the manipulation task In some implementations, the end effector system may include an actuator system and the controller may be configured to receive actuator data associated with the actuator system, generate, based on the actuator data, a manipulation command, and cause, based on the manipulation command, the manipulation task to be performed. In some implementations, the end effector system may include a sensor system and the controller may be further configured to receive sensor data associated with the sensor system, generate, based on the sensor data, a manipulation command, and cause, based on the manipulation command, the manipulation task to be performed. In some implementations, the fingertip device may be exchangeably mounted to the gripper platform and the controller may be further configured to determine a different manipulation task and cause, based on the different manipulation task, at least one of a different fingertip device to be exchanged with the fingertip device such that the different fingertip device is exchangeably mounted to the gripper platform, or a different tool, of the multiple tools, to be exchanged with the tool such that the different tool is mounted to the tool base. The controller may cause the different manipulation task to be performed using the at least one of the different fingertip device or the different.

In some implementations, the fingertip device and the tool base may be independently actuatable. In some implementations, the finger base and the tool base may include at least one of an electromagnetic-based exchange interface, an electromechanical-based exchange interface, a vacuum-based exchange interface, a hydraulic-based exchange interface, a pneumatic-based exchange interface, an adhesive-based exchange interface, an adaptive-based exchange interface, or a demagnetization-based exchange interface. In some implementations, the gripper platform may be operatively couplable to at least one of a robot or a human. In some implementations, the controller may cause the gripper platform to form the gripper platform configuration by autonomously releasably attaching at least one of a set of fingertips, of the multiple fingertips, to corresponding finger bases via corresponding automatic fingertip exchange interfaces, or a tool, of the multiple tools, to the tool base via the tool base exchange interface, as described in more detail elsewhere herein. In some implementations, the controller may cause the manipulation task to be performed using the at least one of the set of fingertips or the tool, as described in more detail elsewhere herein.

In some implementations, the gripper platform configuration may include an autonomous releasable attachment of the set of fingertips and the tool, and the tool may be an object. The controller may use the actuator system to directly manipulate the object via the set of fingertips and indirectly manipulate the object via the tool base.

In some implementations, the controller may receive at least one of sensor data from the sensor system, or actuator data from the actuator system. The controller may generate, based on the at least one of the sensor data or the actuator day, a manipulation command. The controller may cause, based on the manipulation command, the manipulation task to be performed using the at least one of the set of fingertips or the tool.

In some implementations, the controller may receive a different a request to perform a different manipulation task. The controller may determine, and based on the different manipulation task, a different gripper platform configuration of the gripper platform. The controller may cause the gripper platform to form the different gripper platform configuration by autonomously releasably exchanging the at least one of the set of fingertips with at least one of a different set of fingertips or autonomously releasably exchanging the tool with a different tool. The controller may cause the different manipulation task to be performed using the different set of fingertips or the different tool.

In some implementations, the actuator system may include a tool base actuator having at least one internal degree of freedom; however, the tool base may have any suitable DOFs.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise forms disclosed. Modifications may be made in light of the above disclosure or may be acquired from practice of the implementations.

As used herein, the term “component” is intended to be broadly construed as hardware, software, and/or a combination of hardware and software. It will be apparent that systems and/or methods described herein may be implemented in different forms of hardware, software, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c”is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An end effector system, comprising:
a gripper platform;
a tool base operatively coupled to the gripper platform; and
a fingertip device mounted to the gripper platform.

2. The end effector system of claim 1, further comprising:
a finger base configured to exchangeably mount the fingertip device.

3. The end effector system of claim 1, further comprising:
a tool configured to be exchangeably mounted to the tool base.

4. The end effector system of claim 1, wherein the fingertip device and the tool are independently actuatable.

5. The end effector system of claim 1, wherein the gripper platform is operatively couplable to at least one of:
a robot, or
a human.

6. The end effector system of claim 1, wherein the fingertip device includes at least two fingertip devices mounted to the gripper platform.

7. The end effector system of claim 1, further comprising:
multiple tools configured to be available for being exchangeably mounted to the tool base; and
a controller configured to:
determine a manipulation task,
cause, based on the manipulation task, a tool, of the multiple tools, to be exchangeably mounted to the tool base; and
cause the manipulation task to be performed using the tool.

8. The end effector system of claim 6, wherein the controller is further configured to:
cause the fingertip device to directly manipulate the tool to perform the manipulation task.

9. The end effector system of claim 6, further comprising:
an actuator system,
wherein the controller is further configured to:
receive actuator data associated with the actuator system;
generate, based on the actuator data, a manipulation command; and
cause, based on the manipulation command, the manipulation task to be performed.

10. The end effector system of claim 6, further comprising:
a sensor system,
wherein the controller is further configured to:
receive sensor data associated with the sensor system;
generate, based on the sensor data, a manipulation command; and
cause, based on the manipulation command, the manipulation task to be performed.

11. The end effector system of claim 6, wherein the fingertip device is exchangeably mounted to the gripper platform, and
wherein the controller is further configured to:
determine a different manipulation task;
cause, based on the different manipulation task, at least one of:
a different fingertip device to be exchanged with the fingertip device such that the different fingertip device is exchangeably mounted to the gripper platform, or
a different tool, of the multiple tools, to be exchanged with the tool such that the different tool is mounted to the tool base; and
cause the different manipulation task to be performed using the at least one of the different fingertip device or the different.

12. A method, comprising:
determining, by a controller of an end effector system, a manipulation task,
wherein the end effector system further includes:
a gripper platform,
a tool base operatively coupled to the gripper platform;
multiple tools configured to be available for being exchangeably mounted to the tool base, and
a fingertip device mounted to the gripper platform;
causing, by the controller and based on the manipulation task, a tool, of the multiple tools, to be exchangeably mounted to the tool base; and
causing, by the controller, the manipulation task to be performed using the tool.

13. The method of claim 12, wherein the end effector system further includes a finger base configured to exchangeably mount the fingertip device.

14. The method of claim 12, wherein the fingertip device and the tool are independently actuatable.

15. The method of claim 12, further comprising:
causing, by the controller, the fingertip device to directly manipulate the tool to perform the manipulation task.

16. The method of claim 12, wherein the end effector system further includes an actuator system, and
wherein the method further comprises:
receiving, by the controller, actuator data associated with the actuator system;
generating, by the controller and based on the actuator data, a manipulation command; and
causing, by the controller and based on the manipulation command, the manipulation task to be performed.

17. The method of claim 12, wherein the end effector system further includes a sensor system, and
wherein the method further comprises:
receiving, by the controller, sensor data associated with the sensor system;
generating, by the controller and based on the sensor data, a manipulation command; and
causing, by the controller and based on the manipulation command, the manipulation task to be performed.

18. The method of claim 12, wherein the fingertip device is exchangeably mounted to the gripper platform, and
wherein the method further comprises:
determining, by the controller, a different manipulation task;
causing, by the controller and based on the different manipulation task, at least one of:
a different fingertip device to be exchanged with the fingertip device such that the different fingertip device is exchangeably mounted to the gripper platform, or
a different tool to be exchanged with the tool such that the different tool is mounted to the tool base; and
causing, by the controller, the different manipulation task to be performed using the at least one of the different fingertip device or the different tool.

19. A non-transitory computer-readable medium storing a set of instructions, the set of instructions comprising:
one or more instructions that, when executed by one or more processors of an end effector system, cause the end effector system to:
determine a manipulation task, wherein the end effector system further includes:
a gripper platform,
a tool base operatively coupled to the gripper platform;
multiple tools configured to be available for being exchangeably mounted to the tool base, and
a fingertip device mounted to the gripper platform;
cause, based on the manipulation task, a tool, of the multiple tools, to be exchangeably mounted to the tool base; and
cause the manipulation task to be performed using the tool.

20. The non-transitory computer-readable medium of claim 19, wherein the more instructions that, when executed by the one or more processors of the end effector system, further cause the end effector system to:
cause the fingertip device to directly manipulate the tool to perform the manipulation task.
